(19) United States
(12) Patent Application Publication
(10) Pub. No.: US 2023/0169779 A1
(43) Pub. Date: Jun. 1, 2023

(54) VEHICLE CONTROL APPARATUS

(71) Applicant: Honda Motor Co., Ltd., Tokyo (JP)

(72) Inventors: Jens Nessler, Offenbach/Am Main (DE); Marcus Kleinehagenbrock, Offenbach/Am Main (DE)

(21) Appl. No.: 17/990,731

(22) Filed: Nov. 20, 2022

(30) Foreign Application Priority Data
Nov. 26, 2021 (JP) 2021-191801

(51) Int. Cl. G06V 20/58; G01C 21/30

(52) U.S. Cl. CPC G06V 20/582; G01C 21/30; B60K 31/0066

(57) ABSTRACT

A vehicle control apparatus comprising an actuator used for traveling, an output device outputting an information, and a microprocessor. The microprocessor is configured to perform capturing an image ahead of the vehicle, recognizing a road sign included in an imaging range of the image captured in the capturing, determining, when the road sign is recognized in the recognizing while the vehicle is traveling on a merging lane merging into a main lane, whether or not the road sign is only applicable to the vehicle traveling on the merging lane based on a road curvature at a recognition position of the road sign, and controlling at least one of the output devices and the actuator based on an information of the road sign when it is determined in the determining that the road sign is only applicable to the vehicle traveling on the merging lane.

### CROSS-REFERENCE TO RELATED APPLICATION

This application is based upon and claims the benefit of priority from Japanese Patent Application No. 2021-191801 filed on Nov. 26, 2021, the content of which is incorporated herein by reference.

### BACKGROUND OF THE INVENTION

### Field of the Invention

This invention relates to a vehicle control apparatus configured to control traveling of a vehicle, especially control the traveling at a point where a merging lane merges into a main lane.

### Description of the Related Art

Conventionally, there is a known apparatus configured to control a vehicle speed based on an indicated road sign and road surface sign, for example, in Japanese Unexamined Patent Publication No. 2005-128790 (JP2005-128790A). In the apparatus described in JP2005-128790A, the speed limit indicated by the road sign and road surface sign is recognized based on an image obtained by capturing the space ahead of the vehicle, and the vehicle speed is controlled based on the recognized speed limit.

However, when a road sign is installed near a merging point where a merging lane merges into a main lane such a highway, it is difficult to determine whether or not the road sign corresponds to the main lane based on the captured image. Therefore, if an apparatus merely recognizes the information of the road sign based on the captured image, such as JP 2005-128790, it may not be able to properly control the vehicle speed at or after the merging point.

### SUMMARY OF THE INVENTION

An aspect of the present invention is a vehicle control apparatus comprising an actuator used for traveling, an output device outputting an information, and a microprocessor and a memory coupled to the microprocessor. The microprocessor is configured to perform capturing an image ahead of the vehicle, recognizing a road sign included in an imaging range of the image captured in the capturing, determining, when the road sign is recognized in the recognizing while the vehicle is traveling on a merging lane merging into a main lane, whether the road sign is applicable to not only the vehicle traveling on the merging lane but also the vehicle traveling on the main lane based on a road curvature at a recognition position of the road sign, and controlling at least one of the output devices and the actuator based on an information of the road sign when it is determined in the determining that the road sign is applicable to the vehicle traveling on the merging lane.

### BRIEF DESCRIPTION OF THE DRAWINGS

The objects, features, and advantages of the present invention will become clearer from the following description of embodiments in relation to the attached drawings, in which:

FIG. 1A is a diagram showing an example of a traveling scene of a vehicle having a vehicle control apparatus according to an embodiment of the present invention;

FIG. 1B is a diagram showing another example of a traveling scene of a vehicle having the vehicle control apparatus according to the embodiment of the present invention;

FIG. 1C is a diagram showing another example of a traveling scene of a vehicle having the vehicle control apparatus according to the embodiment of the present invention;

FIG. 2 is a block diagram schematically showing a configuration of main components of the vehicle control apparatus according to the embodiment of the present invention; and

FIG. 3 is a flowchart showing an example of processing executed by the controller of FIG. 2.

### DETAILED DESCRIPTION OF THE INVENTION

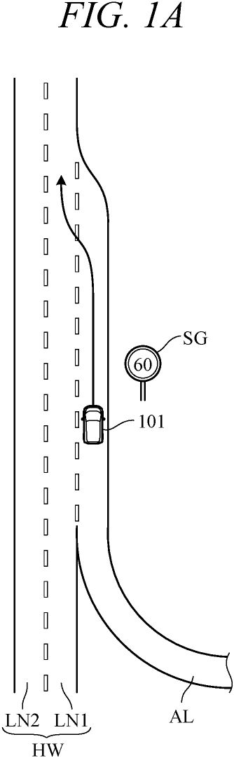

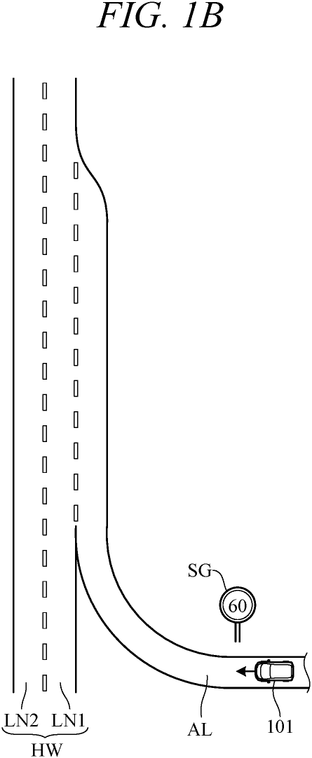

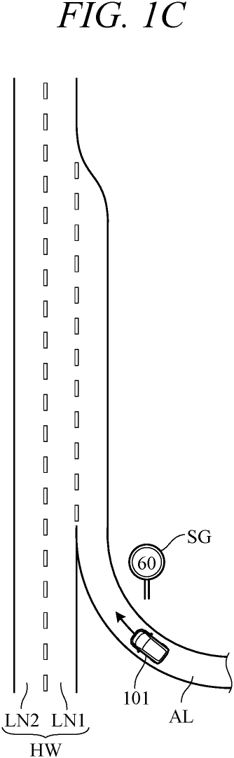

A description will be given below of an embodiment of the present invention with reference to FIG. 1A to 3. A vehicle control apparatus according to the embodiment of the present invention can be applied to a vehicle having a self-driving capability, that is, an automated vehicle. A vehicle to which the vehicle control apparatus according to the present embodiment is applied may be sometimes called a subject vehicle by distinguishing it from other vehicles. The subject vehicle may be any of an engine vehicle having an internal combustion engine as a travel drive source, an electric vehicle having an electric motor as a travel drive source, and a hybrid vehicle having a combustion engine and an electric motor as a travel drive source. The subject vehicle can not only travel in the automated driving mode where driving operation by the driver is unnecessary, but also travel in the manual driving mode by driving operation of the driver.

FIGS. 1A to 1C are diagrams illustrating exemplary driving scenes of the subject vehicle having the vehicle control apparatus according to the embodiment of the present invention. In FIGS. 1A to 1C, respectively, an example is shown in which the subject vehicle 101 travels an acceleration lane (hereinafter, also referred to as “merging lane”) that merges into the highway HW with two lanes (lanes LN1 and LN2) on one side. A road sign (speed limit sign) SG, which indicates that the maximum vehicle speed is limited to 60 km/h, is installed on the merging lane AL. The highway is explained as an example of the main lain, but it is applicable not only to the highway but also to any roads where a main lane and a merging lane are provided.

When the road sign SG installed on the straight section of the merging lane AL (a straight section installed ahead of the curve section) is recognized as shown in FIG. 1A, the subject vehicle 101 recognizes that the maximum vehicle speed is limited to 60 km/h after passing the road sign SG. That is, the subject vehicle 101 recognizes that the road sign SG is applicable to the subject vehicle 101 on the merging lane AL after passing the road sign SG and the subject vehicle 101 on the highway HW. On the contrary, when the road sign SG, installed on the straight section before the curve section of the merging lane AL, is recognized as shown in FIG. 1B, the subject vehicle 101 recognizes that the maximum vehicle speed is limited to 60 km/h until the subject vehicle 101 enters the highway HW. That is, the subject vehicle 101 recognizes that the road sign SG is applicable to the subject vehicle 101 only as long as the subject vehicle 101 is traveling on the merging lane AL. In other words, it is difficult to determine a section to which the road sign SG installed on the straight section of the merging lane AL applies. In this case, when the subject vehicle 101 enters the highway HW from the merging lane AL, it may not be possible to execute appropriate vehicle speed control according to the road sign SG.

However, when the road sign SG is installed on a curve section with relatively large curvature, which is often provided at the merging lane AL as shown in FIG. 1C, it can be determined that the road sign SG is only applicable to the subject vehicle 101 traveling on the merging lane AL and is not applicable to applicable to the subject vehicle 101 traveling on the highway HW. Therefore, in the present embodiment, the vehicle control apparatus is configured as follows.

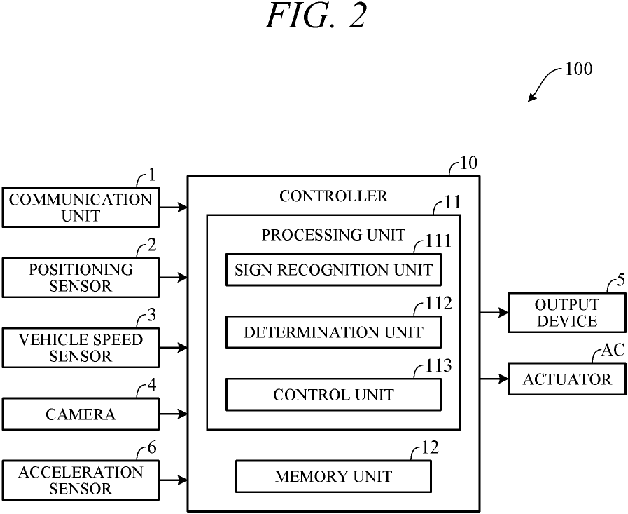

FIG. 2 is a block diagram schematically showing a configuration of main components of the vehicle control apparatus 100 according to the embodiment of the present invention. As shown in FIG. 2, the vehicle control apparatus 100 includes a controller 10, a communication unit 1, a positioning sensor 2, a vehicle speed sensor 3, a camera 4, an output device 5, an acceleration sensor 6, and an actuator AC. The positioning sensor 2, the vehicle speed sensor 3, the camera 4, the output device 5, the acceleration sensor 6, and the actuator AC are communicatively connected to the controller 10, respectively.

The communication unit 1 communicates with various servers (not shown) through a network including a wireless communication network such as an Internet network or a cellular telephone network, and acquires map information, traffic information, and the like from a server periodically or at an arbitrary timing. The network includes not only a public wireless network, but also a closed communications network established for a predetermined administrative area, such as a wireless LAN, Wi-Fi (registered trademark), or Bluetooth (registered trademark). The acquired map information is output to the memory unit 12 (to be described later) and updated as needed.

The positioning sensor 2 receives a signal for positioning transmitted from the positioning satellite. The positioning satellite is an artificial satellite such as a GPS satellite or a quasi-zenith satellite. Using the position information received by the positioning sensor 2, the current traveling position of the subject vehicle 101 (latitude, longitude, altitude) is determined. The positioning sensor 2 is used to determine the position of the subject vehicle 101. It is also possible to use a distance sensor (radar, lidar, etc.) determining the distance from the subject vehicle 101 to an object (object installed on the road) instead of the positioning sensor 2 for measuring the current traveling position. In this case, based on the position information of the object installed on the road obtained from the map information stored in the memory unit 12 (to be described later) and the distance information to the object obtained by the positioning sensor 2, the position of the subject vehicle 101 is determined. The positioning sensor 2 may be used together with the distance sensor. The vehicle speed sensor 3 determines the travel speed of the subject vehicle 101. The acceleration sensor 6 determines acceleration in the left-right direction (lateral acceleration) of the subject vehicle 101. The acceleration sensor 6 may also determine acceleration in the front-back direction (longitudinal acceleration) and in the up-down direction (vertical acceleration) of the subject vehicle 101.

The camera 4 has an image sensor such as a CCD or a CMOS. The camera 4 may be a monocular camera or a stereo camera. The camera 4 captures a periphery of the subject vehicle 101. The camera 4 is, for example, attached to a predetermined position of the front portion of the subject vehicle 101. The camera 4 continuously captures the space ahead of the subject vehicle 101 to acquire image data (hereinafter, referred to as “captured image data” or simply “captured image”) of the object.

The output device 5 is a generic name of a device for outputting information to a driver. For example, the output device 5 includes a display for providing information to a driver via a display image, a speaker for providing information to the driver in sound, and the like.

The actuator AC is a traveling actuator for controlling the traveling of the subject vehicle 101. If the travel drive source is a combustion engine, the actuator AC includes a throttle actuator that adjusts the opening of the throttle valve of the engine. If the travel drive source is an electric motor, the electric motor is included in the actuator AC. The actuator AC also includes a brake actuator for actuating a braking device of the subject vehicle 101 and a steering actuator for driving a steering device of the subject vehicle 101.

The controller 10 comprises an electronic control unit (ECU). More specifically, the controller 10 includes a computer having a processing unit 11 such as a central processing unit (microprocessor), a memory unit 12 such as ROM and RAM, and other peripheral circuits (not shown) such as an I/O interface. Although a plurality of ECUs having different functions, such as a combustion engine control ECU, an electric motor control ECU, and an ECU for the braking device, can be provided separately, the controller 10 is shown in FIG. 2 as a set of these ECUs for convenience.

The memory unit 12 stores high-precision detailed map information, which is referred to as high-precision map information. The high-precision map information includes position information of roads, information on the shapes of roads (curvature, etc.), information on the slopes of roads, position information of intersections and branching points, information on the number of lanes, and width of lanes, position information for each lane (information on the center position of lanes and the boundary line of lanes), position information of landmarks (traffic lights, buildings, etc.) on the map, information on road signs (position, type, regulatory information, etc.), information on road surface profiles such as unevenness of the road surface, etc. The memory unit 12 also stores various control programs, thresholds used in the programs, and other information.

The processing unit 11 includes, as functional configurations, a sign recognition unit 111, a determination unit 112, and a control unit 113. The sign recognition unit 111 detects road signs included in the imaging range based on the captured image obtained by the camera 4. The sign recognition unit 111 recognizes information on a detected road sign, for example, information on the type (warning sign and restriction sign), the content, the position where the road sign is recognized (hereinafter referred to as “recognition position”), and the like based on the captured image obtained by the camera 4 and to store in the memory unit 12. When the information of the road signs is stored in the memory unit 12 in a predetermined amount or more, the sign recognition unit 111 deletes the information of the road sign in order from the road sign with the oldest recognition time.

When the road sign SG is recognized by the sign recognition unit 111 when the subject vehicle 101 is traveling on the merging lane AL that merges into the highway HW, the determination unit 112 determines whether or not the road sign SG is only applicable to the subject vehicle 101 traveling on the merging lane AL based on the curvature of the traveling road (hereinafter referred to as “road curvature”) at the recognition position of the road sign SG.

Specifically, the determination unit 112 determines that the road sign SG is only applicable to the subject vehicle 101 traveling on the merging lane AL when the road curvature at the recognition position of the road sign SG is equal to or greater than a predetermined value. On the contrary, when the road curvature at the recognition position of the road sign SG is less than the predetermined value, the determination unit 112 may determine that the road sign SG is also applicable to the subject vehicle 101 traveling on the highway HW.

Incidentally, the determination unit 112 calculates the road curvature at the recognition position of the road sign SG based on the captured image obtained by the camera 4. At this time, the determination unit 112 calculates the road curvature at the recognition position of the road sign SG based on the road shape of the merging lane AL and the installation position (recognition position) of the road sign SG which are recognized from the captured image of the camera 4. The determination unit 112 may determine the yaw rate, the yaw angle, the pitch rate, the pitch angle, the roll rate, the roll angle, and the like of the subject vehicle 101 while moving to calculate the road curvature at the recognition position of the road sign SG. In addition, the determination unit 112, based on the information of the recognition position of the road sign SG stored in the memory unit 12, may acquire the road curvature at the recognition position of the road sign SG from the map information stored in the memory unit 12.

When it is determined that the road sign SG is only applicable to the subject vehicle 101 traveling on the merging lane AL, the control unit 113 controls the actuator AC so that the subject vehicle 101 travels according to the limited speed indicated by the road sign SG until the subject vehicle 101 enters the highway HW. On the contrary, when it is determined that the road sign SG also is applicable to the subject vehicle 101 traveling on the highway HW, the control unit 113 controls the actuator AC so that the subject vehicle 101 travels according to the limited speed indicated by the road sign SG until a new road sign is recognized after the subject vehicle 101 enters the highway HW.

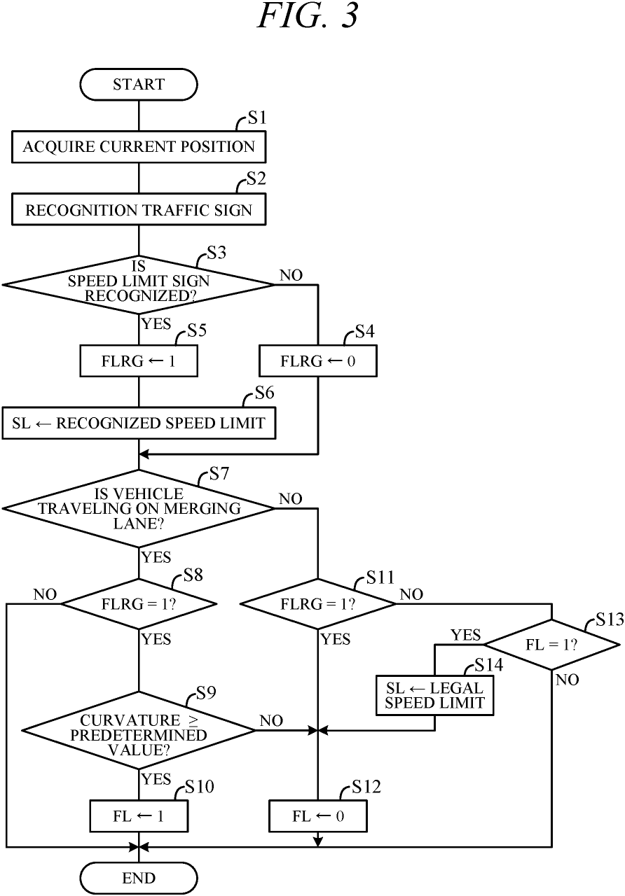

FIG. 3 is a flowchart showing an example of processing executed by the controller 10 of FIG. 2. The processing shown in this flowchart, for example, is executed repeatedly in a predetermined cycle (predetermined period T) while the subject vehicle 101 is traveling in the automated driving mode.

As shown in FIG. 3, first, in S1 (S: process step), based on the position information received by the positioning sensor 2 and the map information stored in the memory unit 12, the current position (current traveling position) of the subject vehicle 101 is acquired. In S2, a traffic sign recognition process is performed based on the captured image of the camera 4. In S3, it is determined whether a speed limit sign SG has been recognized in S2. If the result in S3 is YES, in S5, a flag FLRG is set to 1. The flag FLRG represents whether the speed limit information has been recognized by 1 (TRUE) and 0 (FALSE). The flag FLRG is stored in the memory unit 12. In S6, a speed limit information SL is set to the speed limit indicated by the speed limit sign recognized in S2. The speed limit information SL is stored in the memory unit 12. If the result in S3 is NO, in S4, the FLRG is set to 0, and then, the process proceeds to S7.

In S7, based on the current position of the subject vehicle 101 acquired in S1, it is determined whether or not the subject vehicle 101 is traveling on a merging lane. If the result in S7 is YES, in S8, it is determined whether or not the FLRG is 1. If the result in S8 is NO, the process is terminated. If the result in S8 is YES, in S9, it is determined whether or not the road curvature at the recognition position of the speed limit sign recognized in S2 is equal to or greater than the predetermined value. The road curvature, as described above, may be determined based on the captured image of the camera 4 or the like, may be acquired based on the map information stored in the memory unit 12, or may be estimated from a map prepared in advance based on the lateral acceleration acquired by the acceleration sensor 6 and the vehicle speed acquired by the vehicle speed sensor 3. The predetermined value is a threshold value used to determine whether the recognition position of the speed limit sign recognized by the subject vehicle 101 traveling on a merging lane is included in the curve section. For example, 500R (0.002) is set to the predetermined value.

If the result in S9 is YES, in S10, the flag FL is set to 1, and then, the process is terminated. If the result in S9 is NO, in S12, the flag FL is set to 0, and then, the process is terminated. The flag FL represents whether or not the speed limit information SL have been updated with the speed limit indicated by the speed limit sign installed on a curve section having a curvature equal to or greater than the predetermined value by 1 (TRUE) and 0 (FALSE), and is stored in the memory unit 12. Incidentally, the flag FL is initialized to 0 in advance. If the result in S7 is NO, that is, if it is determined that the subject vehicle 101 is traveling on a main lane (highway), in S11, it is determined whether or not the flag FLRG is 1. If the result in S1 1 is YES, the process proceeds to S12 to set flag FL to 0, and then, the process is terminated. If the result in S1 1 is NO, in S13, it is determined whether or not the flag FL is 1.

If the result in S13 is YES, in S14, the speed limit information SL is set to the speed limit (legal speed limit) set in advance on the main lane. And then, the process proceeds to S12 to set flag FL to 0, and the process is terminated. If the result in S13 is NO, the process is terminated. Thereby, when a speed limit sign is recognized while traveling on a curve section on a merging lane, the speed limit sign is only applicable to the subject vehicle 101 traveling on the merging lane, and after the subject vehicle 101 enters a main lane (highway), the subject vehicle 101 travels according to the legal speed limit. On the contrary, when a speed limit sign is recognized while traveling on a straight section ahead of the curve section on the merging lane, the speed limit sign is applicable to the subject vehicle 101 on the merging lane AL after passing the road sign SG and the subject vehicle 101 on the main lane.

The control unit 113 controls the actuator AC based on the speed limit information SL that is updated by the repeated execution of the processing in FIG. 3. More specifically, the control unit 113 controls the actuator AC so that the vehicle speed detected by the vehicle speed sensor 3 does not exceed the speed limit indicated by the speed limit information SL.

The operation of the vehicle control apparatus 100 according to the present embodiment will be summarized as follows. If the subject vehicle 101 recognizes the road sign SG (in FIG. 1C) installed on the curve section of the merging lane AL and the road curvature at the recognition position is equal to or more than the predetermined value, the speed limit information SL is set to the speed limit indicated by the road sign SG (S1 to S3, S5, S6), and the flag FL is set to 1 (S7 to S10). Thereafter, the subject vehicle 101 travels according to the speed limit indicated by the road sign SG until the subject vehicle 101 enters the highway HW (S1 to S4, S7, S8), and after the subject vehicle 101 enters the highway HW, the subject vehicle 101 travels according to the legal speed limit (S1 to S4, S7, S11, S13, S14, S12). Thereafter, when a new road sign is recognized, the speed limit indicated by the new road sign is set in the speed limit information SL (S1 to S3, S5, S6), and the subject vehicle 101 travels according to the speed limit indicated by the new road sign (S7, S11, S13).

On the contrary, if the subject vehicle 101 recognizes the road sign SG (in FIG. 1A) installed on the straight section ahead of the curve section of the merging lane AL, the speed limit information SL is set to the speed limit indicated by the road sign SG (S1 to S3, S5 to S9, S12). Thereafter, the subject vehicle 101 continues to travel according to the speed limit indicated by the road sign SG as long as no new road sign is recognized (S1 to S4, S7, S11, S13). And then, if the new road sign is detected, the subject vehicle 101 travels according to the speed limit indicated by the new road sign (S1 to S3, S5 to S7, S11, S12). In addition, when the subject vehicle 101 recognizes the road sign SG (in FIG. 1B) installed on the straight section before the curve section of the merging lane AL, the subject vehicle 101 travels according to the speed limit indicated by the road sign SG until the subject vehicle 101 enters the highway HW as when the subject vehicle 101 recognizes the road sign SG (in FIG. 1C) installed on the curve section of the merging lane AL. After entering the highway HW, the subject vehicle 101 continues to travel according to the speed limit indicated by the road sign SG. Thereafter, when a new road sign is recognized, the speed limit indicated by the new road sign is set in the speed limit information SL, the subject vehicle 101 travels according to the speed limit indicated by the new road sign. It may be performed based on the captured image by the camera 4, the map information stored in the memory unit 12 and so on to determine whether the current position of the subject vehicle 101 when the road sign SG is recognized is before the curve section (in FIG. 1A) or ahead of the curve section (in FIG. 1B).

The present embodiment can achieve advantages and effects such as the following:

The vehicle control apparatus 100 includes the camera 4 capturing an image ahead of the subject vehicle 101, the sign recognition unit 111 recognizing a road sign included in an imaging range of the image captured by the camera 4, the determination unit 112, when the road sign SG is recognized by the sign recognition unit 111 while the subject vehicle 101 is traveling on the merging lane AL merging into the highway HW which is the main lane, determining whether or not the road sign SG is only applicable to the subject vehicle 101 traveling on the merging lane AL based on the road curvature at the recognition position of the road sign SG, more specifically, installation position of the road sign SG recognized by the sign recognition unit 111, and a control unit 113 controlling the actuator AC so that the subject vehicle 101 is traveling on the merging lane AL according to the road sign recognized by the sign recognition unit 111 when the determination unit 112 determines that the road sign is only applicable to the subject vehicle 101 traveling on the merging lane. Thus, it is possible to make a good approach from the merging lane to the main lane according to the speed limit sign installed on the merging lane. As a result, the safety of traffic at or after the merging point can be improved, and a sustainable transportation system can be constructed.

The determination unit 112 determines that the road sign SG recognized by the sign recognition unit 111 is applicable to the subject vehicle 101 traveling on the merging lane AL when the road curvature at the recognition position of the road sign SG is greater than or equal to the predetermined value. As a result, when the road sign is installed on the curve section of the merging lane, it can be appropriately determined whether the road sign is only applicable to the subject vehicle 101 traveling on the merging lane or also the subject vehicle 101 traveling on the main lane.

The determination unit 112 calculates the road curvature at the recognition position of the road sign SG based on the captured image obtained by the camera 4, and determines whether the road sign SG recognized by the sign recognition unit 111 is applicable to not only the subject vehicle 101 traveling on the merging lane AL but also the vehicle traveling on the main lane on the basis of the calculated road curvature. Thus, it is possible to calculate the road curvature using the existing in-vehicle camera without adding a new configuration.

The vehicle control apparatus 100 further includes a memory unit 12 that stores map information of roads. The determination unit 112 acquires the road curvature at the position where the road sign is recognized by the sign recognition unit 111 from the map information stored in the memory unit 12, and determines whether the road sign recognized by the sign recognition unit 111 is applicable to not only the subject vehicle 101 traveling on the merging lane based on the acquired road curvature but also the vehicle traveling on the main lane. Thereby, the road curvature at the recognition position of the road sign can be more accurately acquired, and it can be more appropriately determined whether the road sign is applied to the subject vehicle 101 traveling on the merging lane or the subject vehicle 101 traveling on the main lane.

The vehicle control apparatus 100 further includes an acceleration sensor 6 detecting lateral acceleration of the subject vehicle 101 and a vehicle speed sensor 3 detecting a travel speed of the subject vehicle 101. The determination unit 112 acquires the road curvature at the position where the road sign is recognized by the sign recognition unit 111 based on the lateral acceleration detected by the acceleration sensor 6 and the travel speed detected by the vehicle speed sensor 3, and determines whether or not the road sign recognized by the sign recognition unit 111 is applicable to not only the subject vehicle 101 traveling on the merging lane based on the acquired road curvature but also to the vehicle traveling on the main lane. Thus, it is possible to accurately acquire the road curvature without providing a special sensor for acquiring the road curvature.

The above embodiment may be modified in various modifications. Several modifications will be described below. In the above embodiment, the camera 4 serving as a capturing unit is adapted to detect surrounding circumstances of the subject vehicle 101 (circumstances ahead of the subject vehicle 101), as long as it detects surrounding circumstances of the subject vehicle 101, the configuration of an in-vehicle detector is not limited to this. For example, the in-vehicle detector may be a radar or a lidar. Further, in the above embodiment, the sign and the like included in the image captured by the camera 4 is detected, but a sign recognition unit may detect the sign and the like based on information obtained by a radar or a lidar. In the above embodiment, the lateral acceleration of the subject vehicle 101 is detected by the acceleration sensor 6 serving as an acceleration detection unit, but the configuration of the acceleration detection unit is not limited to this. In the above embodiment, the traveling speed of the subject vehicle 101 is detected by the vehicle speed sensor 3 serving as a traveling speed detection unit, but the configuration of the traveling speed detection unit is not limited to this.

Further, in the above embodiment, the vehicle control apparatus 100 is applied to the automated vehicle, but the vehicle control apparatus 100 is also applicable to vehicles other than the automated vehicle. For example, the vehicle control apparatus 100 can be applied to a manually operated vehicle including ADAS (Advanced Driver Assistance system).

Furthermore, in the above embodiment, an example has been shown in which the processing of FIG. 3 is executed while the subject vehicle 101 is traveling in the automated mode, but the processing of FIG. 3 may be executed while the subject vehicle 101 is traveling in the manual drive mode. In that case, the output device 5 serving as a notification unit is controlled together with the actuator AC or in place of the actuator AC by the control unit 113 based on the speed limit information SL which is updated by the processing of FIG. 3, which is repeatedly executed. Incidentally, the output device 5 serving as the notification unit may be controlled together with the actuator AC while the subject vehicle 101 is traveling in the automated mode. That is, a control unit may control at least one of the notification unit and the travel actuator based on the road sign. For example, the control unit controls the output device 5 (display) such that the speed limit indicated by the speed limit information SL is informed to the occupant in an image. Further, for example, the control unit controls the output device 5 (speaker) such that the speed limit indicated by the speed limit information SL is notified to the occupant in voice.

According to the present invention, it is possible to appropriately control the travel speed of the vehicle traveling in the vicinity of the merging point.

The above embodiment can be combined as desired with one or more of the above modifications. The modifications can also be combined with one another.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus comprising:
an actuator used for traveling;
an output device outputting an information; and
a microprocessor and a memory coupled to the microprocessor, wherein
the microprocessor is configured to perform:
capturing an image ahead of the vehicle;
recognizing a road sign included in an imaging range of the image captured in the capturing;
determining, when the road sign is recognized in the recognizing while the vehicle is traveling on a merging lane merging into a main lane, whether the road sign is applicable to not only the vehicle traveling on the merging lane but also the vehicle traveling on the main lane based on a road curvature at a recognition position of the road sign; and
controlling at least one of the output devices and the actuator based on an information of the road sign when it is determined in the determining that the road sign is applicable to the vehicle traveling on the merging lane.

2. The vehicle control apparatus according to claim 1, wherein
the microprocessor is configured to perform
the determining including determining that the road sign recognized in the recognizing is applicable to the vehicle traveling on the merging lane and is not applicable to the vehicle traveling on the main lane when the road curvature at the recognition position of the road sign is greater than or equal to a predetermined value.

3. The vehicle control apparatus according to claim 1, wherein
the microprocessor is configured to perform
the determining including calculating the road curvature at the recognition position of the road sign recognized in the recognizing based on the image captured in the capturing to determine whether the road sign is applicable to not only the vehicle traveling on the merging lane but also the vehicle traveling on the main lane based on the road curvature calculated in the calculating.

4. The vehicle control apparatus according to claim 1, wherein
the memory stores a map information of a road, and
the microprocessor is configured to perform
the determining including acquiring the road curvature at the recognition position of the road sign recognized in the recognizing from the map information stored in the memory to determine whether the road sign is applicable to not only the vehicle traveling on the merging lane but also the vehicle traveling on the main lane based on the road curvature acquired in the acquiring.

5. The vehicle control apparatus according to claim 1, further comprising:
a first sensor detecting an acceleration of the vehicle; and
a second sensor detecting a travel speed of the vehicle, wherein
the microprocessor is configured to perform
the determining including acquiring the road curvature at the recognition position of the road sign recognized in the recognizing based on the acceleration detected by the first sensor and the travel speed detected by the second sensor to determine whether the road sign is applicable to not only the vehicle traveling on the merging lane but also the vehicle traveling on the main lane based on the road curvature acquired in the acquiring.

6. A vehicle control apparatus comprising:
an actuator used for traveling;
an output device outputting an information; and
a microprocessor and a memory coupled to the microprocessor, wherein
the microprocessor is configured to function as:
a capturing unit that captures an image ahead of the vehicle;
a sign recognition unit that recognizes a road sign included in an imaging range of the image captured by the capturing unit;
a determination unit that determines, when the road sign is recognized by the sign recognition unit while the vehicle is traveling on a merging lane merging into a main lane, whether the road sign is applicable to not only the vehicle traveling on the merging lane but also the vehicle traveling on the main lane based on a road curvature at a recognition position of the road sign; and
a control unit that controls at least one of the output devices and the actuator based on an information of the road sign when it is determined by the determination unit that the road sign is applicable to the vehicle traveling on the merging lane.

7. The vehicle control apparatus according to claim 6, wherein
the determination unit determines that the road sign recognized by the sign recognition unit is applicable to the vehicle traveling on the merging lane and is not applicable to the vehicle traveling on the main lane when the road curvature at the recognition position of the road sign is greater than or equal to a predetermined value.

8. The vehicle control apparatus according to claim 6, wherein
the determination unit calculates the road curvature at the recognition position of the road sign recognized by the sign recognition unit based on the image captured by the capturing unit to determine whether the road sign is applicable to not only the vehicle traveling on the merging lane but also the vehicle traveling on the main lane based on the road curvature calculated.

9. The vehicle control apparatus according to claim 6, wherein
the memory stores a map information of a road, and
the determination unit acquires the road curvature at the recognition position of the road sign recognized by the sign recognition unit from the map information stored in the memory to determine whether the road sign is applicable to not only the vehicle traveling on the merging lane but also the vehicle traveling on the main lane based on the road curvature acquired.

10. The vehicle control apparatus according to claim 6, further comprising:
a first sensor detecting an acceleration of the vehicle; and
a second sensor detecting a travel speed of the vehicle, wherein
the determination unit acquires the road curvature at the recognition position of the road sign recognized by the sign recognition unit based on the acceleration detected by the first sensor and the travel speed detected by the second sensor to determine whether the road sign is applicable to not only the vehicle traveling on the merging lane but also the vehicle traveling on the main lane based on the road curvature acquired.
